(19) United States
(12) Patent Application Publication
(10) Pub. No.: US 2025/0042298 A1
(43) Pub. Date: Feb. 6, 2025

(54) BATTERY MANAGEMENT SYSTEM AND METHOD FOR EQUALIZING THE CHARGES OF THE ACCUMULATOR CELLS OF THE BATTERY

(71) Applicants: AMPERE S.A.S., Boulogne Billancourt (FR); NISSAN MOTOR CO., LTD., Kanagawa-ku (JP)

(72) Inventors: Samuel CREGUT, Guyancourt Cedex (FR); Fabian Antonio RINCON-VIJA, Guyancourt Cedex (FR)

(73) Assignees: AMPERE S.A.S., Boulogne Billancourt (FR); NISSAN MOTOR CO., LTD., Kanagawa-ku (JP)

(21) Appl. No.: 18/718,545

(22) PCT Filed: Dec. 7, 2022
(86) PCT No.: PCT/EP2022/084868

§ 371 Date: Jun. 11, 2024

(30) Foreign Application Priority Data
Dec. 13, 2021 (FR) 2113412

(51) Int. Cl. B60L 58/22; B60L 58/12; B60L 58/16

(52) U.S. Cl. CPC B60L 58/22; B60L 58/12; B60L 58/16

(57) ABSTRACT

This management system (1) for managing a battery of accumulator cells (2) of an electric vehicle comprises a plurality of secondary controllers (7) coupled respectively to a plurality of accumulator cells (10) of the battery (2) and a primary controller (6) configured to determine the terms for equalizing the charge of the accumulator cells (10) when the management system (1) is in an active mode, the management system (1) comprising an inactive mode in which the terms by which the charges are equalized are determined only by the secondary controllers (7).

### TECHNICAL FIELD

The invention relates, generally, to the systems for managing an accumulator battery.

In particular, the invention relates to the systems for wireless management of an accumulator battery of an electric vehicle.

### PRIOR ARTS

Electric vehicles such as motor vehicles comprise a traction accumulator battery and a service battery. The traction battery is the high-voltage battery powering the electric motor of the vehicle while the service battery is the low-voltage battery common to any vehicle, generally 12 V or 14 V, intended to power the other functionalities, such as various equipment on board the vehicle.

A traction battery of an electric vehicle comprises a plurality of accumulators also called cells. Typically, the battery of an electric motor vehicle comprises 96 accumulators or more, grouped together in nodes of 8 accumulators. For example, the accumulators of the electric or hybrid vehicles are li-ion accumulators.

In order to optimize the lifetime and the upkeep of the traction battery and its performance levels, a system for managing the accumulator battery is used to manage the equalizing of the charges of the accumulators of the battery by a discharging of the accumulators that are most charged into a resistor. The objective is for all of the accumulators to be at the same level of charge.

The accumulator battery management systems generally comprise a master controller powered by the low-voltage battery of the vehicle and a plurality of slave controllers. Each slave controller is coupled to a node of a plurality of accumulators which ensure its power supply and the master controller comprises a computer determining the equalizing terms to be applied by each slave controller to the node with which it is coupled in order to equalize the charges of the accumulators of the battery.

In order to limit the overheating of the resistors, the dissipated power is reduced and the equalizing time is extended. To increase this time, it is known practice to wake up the system periodically, in order to restart the equalizing of the accumulators. The current management systems therefore comprise an active mode and an inactive mode. The active mode corresponds generally to a switching-on of the vehicle and the inactive mode corresponds to a switching-off of the vehicle.

The document WO2019/017595 describes a management system comprising a plurality of slave controllers configured to operate in an active mode and an inactive mode by using the energy supplied by the node of accumulators to which they are coupled. In the active mode, the slave controllers wirelessly transmit a detection signal indicating a state of the node of accumulators to which they are coupled, and a master controller wirelessly transmits a control signal comprising an equalizing term indicating the scanning period and the scanning time required of the slave controller to discharge the node of accumulators to which it is coupled.

Generally, the operation of the system is the same in the active and inactive modes. In inactive mode, the master controller sends signals to the slave controllers, but at a lower frequency. In the inactive mode, the low-voltage battery thereby reduces its autonomy to power the master controller.

The aim of the present invention is therefore to mitigate the abovementioned drawbacks and to propose a system for managing the traction accumulator battery of an electric vehicle comprising an inactive mode that does not provoke any discharging of the low-voltage battery without losing efficiency.

The subject of the invention is therefore a system for managing an accumulator battery of an electric vehicle comprising a plurality of slave controllers respectively coupled to a plurality of accumulators of the battery and a master controller configured to determine terms for equalizing the charge of the accumulators in an active mode of the management system, the management system comprising an inactive mode in which the charge equalizing terms are determined only by the slave controllers.

Advantageously, during the inactive mode each slave controller determines the term for equalizing the plurality of accumulators to which it is coupled.

Advantageously, the master controller is powered by a low-voltage battery and the slave controllers are powered by the traction battery.

Preferentially, the master and slave controllers use wireless communication means.

Also a subject of the invention is a method for equalizing respective charges of accumulators of an accumulator battery of an electric vehicle that can be implemented by a management system as defined above.

Advantageously, the master controller communicates the current circulating in the battery to the slave controllers in the active mode, and the method comprises the following steps in an inactive mode:
A slave controller becomes slave-master controller;
The slave-master controller asks the other slave controllers for the transmission of a minimum voltage from among their plurality of accumulators;
The slave-master controller sends to each of the other slave controllers a minimum voltage of the battery from among the minimum voltages of the pluralities of accumulators of each slave controller;
Each slave controller determines a need for equalization and an equalizing term for its plurality of accumulators.

Preferentially, the method is implemented periodically at very low frequency in the inactive mode.

Advantageously, the step of determining a need for equalization comprises the determination of indicators of the state of the plurality of accumulators by said slave controller.

Preferentially, the state indicators comprise the state of health and the state of charge of the battery.

Advantageously, the slave controller becoming slave-master controller changes each time the method is implemented.

Thus, the charges of the accumulators associated with each slave controller remain equalized during the inactive mode.

Also a subject of the invention is an electric vehicle comprising a traction battery, a low-voltage battery and a traction battery management system as defined above, the system being able to implement a method as defined previously.

Advantageously, the management system comprises a master controller powered by the low-voltage battery of the vehicle and slave controllers powered by the traction battery.

Preferentially, the active mode corresponds to the switching-on of the vehicle and the inactive mode corresponds to the switching-off of the vehicle.

### BRIEF DESCRIPTION OF THE DRAWINGS

Other aims, features and advantages of the invention will become apparent on reading the following description, given purely as a nonlimiting example, and given with reference to the attached drawings in which:

FIG. 1 schematically illustrates a management system according to the invention powered by the batteries of an electric vehicle;

FIG. 2 schematically illustrates the topology of the management system of FIG. 1 in active mode;

FIG. 3 schematically illustrates the temporal organization of the exchanges in active mode of the management system according to FIG. 1 in active mode;

FIG. 4 schematically illustrates the temporal organization of the exchanges in inactive mode of a management system according to the state of the art;

FIG. 5 schematically illustrates the topology of a management system of FIG. 1 in inactive mode;

FIG. 6 schematically illustrates the temporal organization of the exchanges in inactive mode of the management system according to the invention; and

FIG. 7 schematically illustrates an equalizing method according to the invention.

### DETAILED EXPLANATION OF AT LEAST ONE EMBODIMENT

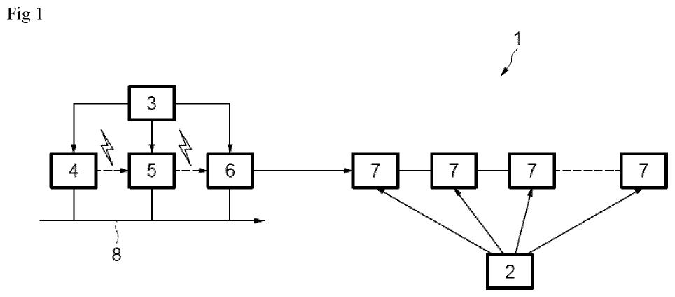

FIG. 1 schematically represents a management system 1 of an accumulator battery 2 according to the invention.

The accumulator battery 2 is an accumulator battery of an electric vehicle, for example a motor vehicle with electric drive.

More specifically, the accumulator battery 2 is a traction battery of the electric vehicle, that is to say that it is the battery powering an electric motor of the electric vehicle. In particular, the traction battery 2 is a high-voltage battery commonly called battery pack.

The electric vehicle comprises a low-voltage battery 3 in addition to the traction battery 2.

The low-voltage battery 3 is a conventional battery present in all vehicles with electric, internal combustion or hybrid motor, and powering the various on-board equipment, also called service battery. The low-voltage battery 3 is generally a 12 V battery.

The electric vehicle comprises a BCM 4, BCM being the acronym for Body Control Module, and which is a standard designation denoting an on-board computer controlling electronic accessories of the vehicle such as the conditioned air or the centralized locking. The electric vehicle additionally comprises a supervisor of the powertrain 5 which is controlled by the BCM 4.

The management system 1 comprises a master controller 6 and a plurality of slave controllers 7.

The supervisor 5 of the powertrain controls the powering up of the master controller 6.

The BCM 4, the supervisor 5 and the master controller 6 are powered by the low-voltage battery 3 via a CAN bus 8, and the plurality of slave controllers 7 are powered by the traction battery 2.

The management system 1 comprises an active mode corresponding to the switching-on of the vehicle and an inactive mode corresponding to the switching-off of the vehicle. The management system 1 is able to switch over between the active and inactive modes upon the occurrence of a trigger event. For example, the trigger event can be the stopping of the vehicle at the end of use, that is to say the switching-off of the vehicle by the user, which provokes the switchover from the active mode to the inactive mode. Another trigger event may be the occurrence of the end of charging of the traction battery 2 of the vehicle.

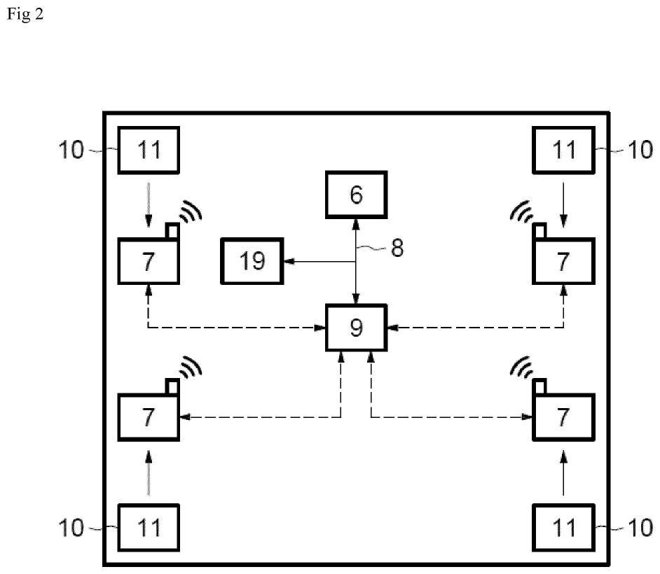

FIG. 2 illustrates the topology of the management system 1 in active mode.

The topology of the management system 1 in active mode is a star around a central gateway 9 coupled to the master controller 6 by the CAN bus 8, and which is powered by the low-voltage battery 3.

The assembly comprising the master controller 6 and the central gateway 9 communicates wirelessly with the slave controllers 7.

The traction battery 2 comprises a set of accumulators 10 grouped together into a plurality of nodes 11. Each slave controller 7 is coupled to a plurality of accumulators 10 forming a node 11.

For example, the traction battery 2 comprises 96 or 100 accumulators grouped together into 12 nodes of 8 accumulators.

Each slave controller 7 communicates only with the assembly comprising the gateway 9 and the master controller 6.

In the active mode, the master controller 6 is configured to determine the equalizing terms for the charge of the accumulators 10.

More specifically, the master controller 6 calculates state indicators using measurements of data such as the voltage or the temperature in the accumulators 10, and deduces therefrom an equalizing term 10 to be applied for each accumulator 10 so as to equalize all of the charges of the accumulators 10 of the traction battery 2.

More specifically, the equalizing term intended to equalize an accumulator 10 is applied to this accumulator 10 by the slave controller 7 to which it is coupled.

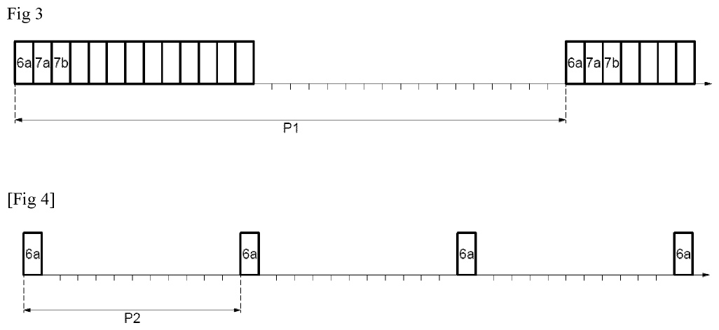

FIG. 3 illustrates a temporal organization of the exchanges between the controllers of the management system 1 in the active mode. The X-axis is a time axis.

In active mode, the exchanges are strung together with a given periodicity P1, for example 100 milliseconds. The period P1 of an exchange is divided into a plurality of time slots for example equal in duration, typically 3 milliseconds. The synchronization is performed by the sending of an initial beacon 6a which is emitted by the master controller 6 via the gateway 9 to all of the slave controllers 7. Following this initial beacon 6a, each slot is dedicated to the sending of information to the assembly comprising the gateway 9 and the master controller 6. This information is sent in a beacon 7a, 7b, etc. by a slave controller 7 and comprises measurements of voltage and of temperature of the accumulators to which the slave controller 7 is coupled. Each slave controller 7 therefore knows the slot in which it has to send its information.

In parallel, the master controller 6 receives the information from each slave controller 7 and determines an equalizing term for each accumulator 10 of the battery 2. This equalizing term is determined notably by the calculation of state indicators relating to the accumulator 10 concerned and to the battery 2. These state indicators comprise the SOH and the SOC, respective acronyms for “State Of Health” and “State Of Charge”, respectively designating the states of health and of charge of the battery 2.

After determining the equalizing term of an accumulator 10, the master controller 6 sends this term to the slave controller 7 to which the accumulator 10 is coupled. This sending is not represented in FIG. 3. The slave controller 7 then applies this equalizing term to the accumulator 10 concerned.

Thus, the charges of the different accumulators 10 of the traction battery 2 are equalized during the active mode.

The operation of the management system 1 in the active mode is similar to the operation of the management systems of the state of the art in active mode.

In the example illustrated in FIG. 3, the traction battery 2 comprises 12 nodes of accumulators 10, the period P1 is 100 milliseconds and the slots have a duration equal to 3 milliseconds.

FIG. 4 illustrates a temporal organization of the exchanges between the controllers of a management system according to the state of the art in the inactive mode. The X-axis represents the time axis.

The management systems of the state of the art retain, in the inactive mode, the topology illustrated in FIG. 2.

In the inactive mode of a management system according to the state of the art, the periodicity of the exchanges is extended, for example to a duration P2 of 300 milliseconds. In addition, the exchanges include no more than one initial synchronization beacon 6a sent by the master controller 6 to all of the slave controllers 7. As long as the beacon 6a does not include a wake-up command, the slave controllers 7 send no information. On the other hand, when the beacon 6a includes a wake-up command, the management system of the state of the art performs an exchange similar to that of the active mode, even if the car is switched off. Typically, during the inactive mode, the beacons 6a that are emitted do not include any wake-up command for several hours. For example, the wake-up command can take place every eight hours.

Thus, the inactive mode makes it possible to extend the equalizing of the charges of the accumulators and thereby limit the overheating of the resistors into which the accumulators are discharged according to their equalizing term.

Nevertheless, this inactive mode according to the state of the art necessitates keeping the gateway 9 on and periodically waking up the master controller 6 in order to send the beacons 6a. To wake up the master controller 6, the BCM 4 which wakes up the supervisor 5 which wakes up the master controller 6 must be woken up. Since the BCM 4, the supervisor 5 and the master controller 6 are powered by the low-voltage battery 3, an excess draw on the autonomy of this low-voltage battery 3 is induced in the inactive mode.

FIG. 5 illustrates the topology of the management system 1 according to the invention in inactive mode.

More specifically, when the management system 1 switches from the active mode to the inactive mode, its topology is modified from the topology illustrated in FIG. 2 to the topology illustrated in FIG. 5.

In the inactive mode, the master controller 6 is no longer the coordinator of the network formed by the controllers. Indeed, one of the slave controllers 7 becomes the coordinator of the network and is thus charged with orchestrating the exchanges in the management system 1. Hereinbelow, this slave controller will be called slave-master controller 12.

Preferentially, the slave controller 7 elected to become slave-master controller 12 in the inactive mode is chosen according to its position in the battery pack 2. More specifically, it is a slave controller 7 coupled to a central node 11.

Alternatively, the slave-master 12 role can change periodically between the slave controllers 7. More specifically, it is possible, in each period of implementation of the method, for a different slave controller 7 to become slave-master controller 12 and send the synchronization beacon to the other slave controllers 7. Similarly, it is possible for each slave controller 7 to have to have served as slave-master controller 12 once before a slave controller 7 becomes master-slave controller 12 a second time. More globally, the slave controller 7 becoming slave-master controller 12 can be designated in such a way that each slave controller in succession becomes slave-master controller in the course of the periodic implementations of the method, and that each slave controller 7 becomes slave-master controller 12 an equivalent number of times in the inactive mode. That makes it possible to not create any inequality between the charges of the accumulators of different slave controllers 7, and to make all the slave controllers 7 have the same energy consumption in the inactive mode. Thus, the equalizing of the battery is not affected.

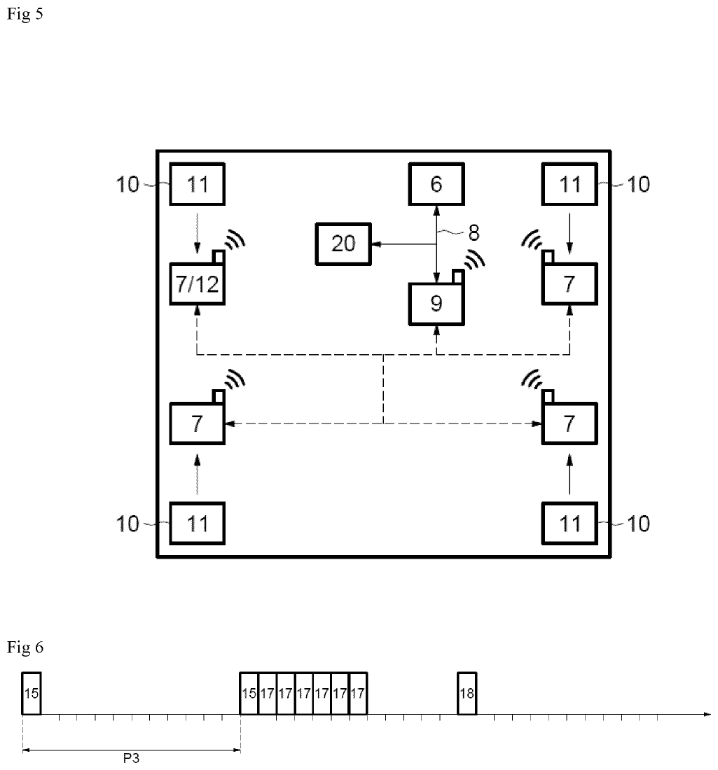

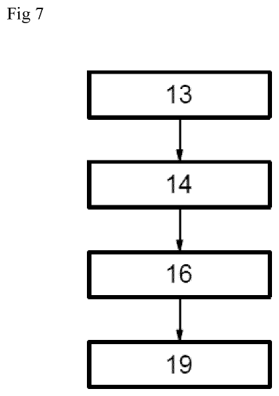

FIG. 6 illustrates a temporal organization of the exchanges between the controllers of the management system 1 in the inactive mode, and FIG. 7 illustrates a method for equalizing the respective charges of the accumulators 10 of the traction battery 2 that can be implemented by a management system 1.

The equalizing method is implemented by the management system 1 in inactive mode at very low frequency, for example with frames that have a periodicity P3 of 10 minutes, because the needs for equalization change very slowly. In this way, the use of the traction battery 2 is economical in the inactive mode.

In a first step 13, a slave controller 7 becomes slave-master controller 12. The term “slave-master controller” means that it is one of the slave controllers 7 which becomes the coordinator of the network and of the equalizing in inactive mode, this role being taken by the master controller 6 in the active mode. Thus, in the inactive mode, the slave controllers 7 do not communicate with the master controller 6 but with the slave-master controller 12, and conversely the master controller 6 does not communicate with the slave controllers 7; it is the slave-master controller 12 which does so.

In a second step 14, the slave-master controller 12 asks the other slave controllers 7 for the transmission of a minimum voltage from among their plurality of accumulators 10.

More specifically, the slave-master controller 12 sends an initial beacon 15 to all of the slave controllers 7 asking for the voltage measurements of the plurality of accumulators 10 to which they are coupled and to send to the slave-master controller 12 the minimum voltage from among these measured voltages.

Each slave controller 7 of the management system is equipped with a computer and sensors allowing it to perform such operations.

In a third step 16, the slave-master controller 12 sends to each of the other slave controllers 7 a minimum voltage of the traction battery 2 from among the minimum voltages of the pluralities of accumulators of each slave controller 7.

More specifically, in the step 14, the slave-master controller 12 receives all of the minimum voltages 17 of each of the nodes of accumulators 10 coupled to a slave controller 7, determines the minimum of these voltages received and returns this minimum in a beacon 18 to all of the slave controllers 7. In the temporal organization illustrated in FIG. 6, the step of sending of the minimum voltages 17 by all of the slave controllers 7 takes place in the periodic frame following that of the first initial beacon 15. However, it can also take place later or directly following the reception of the first initial beacon 15, each slave controller 7 having to observe its sending slot. The same applies for the sending of the beacon 18.

In a fourth step 19, each slave controller 7 determines a need for equalization and possibly an equalizing term for the plurality of accumulators 10 to which it is coupled.

More specifically, each slave controller 7 receives the minimum voltage of the traction battery 2 in the beacon 18. In addition, in the active mode, unlike the state of the art, the master controller 6 transmits the current circulating in the traction battery 2 via the gateway 9 to all of the slave controllers 7. The master controller 6 comprises sensors 20 which allow it to determine the current circulating in the battery 2.

Thus, the slave controllers 7 have information necessary to determine the state indicators of the plurality of accumulators 10 to which they are coupled. These state indicators are for example the state of health or the state of charge of the battery 2.

To determine whether an accumulator 10 to which a slave controller 7 is coupled needs equalization, the slave controller 7 can make a comparison between the voltage of the accumulator and the minimum voltage of the battery 2 received in the beacon 18. In the case where the difference between the voltage of the accumulator 10 and the minimum voltage is less than a predetermined threshold S, there is no need for the equalizing of said accumulator 10 and the equalizing term is therefore zero. Conversely, when the difference is greater than the threshold S, there is a need for equalization and the equalizing term is determined then applied by the slave controller 7.

The threshold S is for example 5 millivolts if the measurement accuracy is less than 2 millivolts.

Thus the need for equalization and the equalizing term are determined in inactive mode only by the slave controllers 7 and not by the master controller 6. This way, since the slave controllers 7 are powered by the traction battery 2 and not by the low-voltage battery 3, the autonomy of the low-voltage battery 3 is not reduced in inactive mode, since the master controller 6 is not used. In addition, since the traction battery 2 has great autonomy, there is no handicap in using it in inactive mode for the use of the slave controllers 7.

1. A system for managing an accumulator battery of an electric vehicle comprising a plurality of slave controllers respectively coupled to a plurality of accumulators of the battery and a master controller configured to determine terms for equalizing the charge of the accumulators in an active mode of the management system, wherein the management system comprises an inactive mode in which the equalizing terms are determined only by the slave controllers.

2. The system as claimed in claim 1, wherein during the inactive mode, each slave controller determines the term for equalizing the plurality of accumulators to which it is coupled.

3. The system as claimed in claim 1, wherein the master controller is powered by a low-voltage battery and the slave controllers are powered by the traction battery.

4. The system as claimed in claim 1, wherein the master and slave controllers use wireless communication means.

5. A method for equalizing respective charges of accumulators of an accumulator battery of an electric vehicle that can be implemented by a management system as claimed in claim 1.

6. The equalizing method as claimed in claim 5, wherein the master controller communicates the current circulating in the battery to the slave controllers in the active mode, the method comprising the following steps in an inactive mode;
A slave controller becomes slave-master controller;
The slave-master controller asks the other slave controllers for the transmission of a minimum voltage from among their plurality of accumulators;
The slave-master controller sends to each of the other slave controllers a minimum voltage of the battery from among the minimum voltages of the pluralities of accumulators of each slave controller;
Each slave controller determines a need for equalization and an equalizing term for its plurality of accumulators.

7. The equalizing method as claimed in claim 5, wherein it is implemented periodically at very low frequency in the inactive mode.

8. The method as claimed in claim 6, wherein the step of determining a need for equalization comprises the determination of indicators of the state of the plurality of accumulators by said slave controller.

9. The method as claimed in claim 8, wherein the state indicators comprise the state of health and the state of charge of the battery.

10. The method as claimed in claim 6, wherein the slave controller becoming slave-master controller changes each time the method is implemented.

11. An electric motor vehicle comprising a traction battery, a low-voltage battery and a traction battery management system as claimed in claim 1.

12. The vehicle as claimed in claim 11, wherein the management system comprises a master controller powered by the low-voltage battery of the vehicle and slave controllers powered by the traction battery.

13. The vehicle as claimed in claim 11, wherein the active mode corresponds to the switching-on of the vehicle and the inactive mode corresponds to the switching-off of the vehicle.
